(19) United States
(12) Patent Application Publication
(10) Pub. No.: US 2015/0117920 A1
(43) Pub. Date: Apr. 30, 2015

(54) IMAGE FORMING APPARATUS

(71) Applicant: CANON KABUSHIKI KAISHA, Tokyo (JP)

(72) Inventor: Junichi Moteki, Abiko-shi (JP)

(21) Appl. No.: 14/523,193

(22) Filed: Oct. 24, 2014

(30) Foreign Application Priority Data
Oct. 28, 2013 (JP) 2013-223084

(51) Int. Cl. G03G 15/20

(52) U.S. Cl. CPC G03G 15/2028
USPC 399/323

(57) ABSTRACT

An image forming apparatus includes: an image forming portion configured to form a toner image on a sheet; a first rotatable member and a second rotatable member which are configured to form a nip therebetween for heating the toner image formed on the sheet by the image forming portion; a separation member configured to separate the sheet in contact with the second rotatable member; a moving mechanism configured to move the separating member so that the separating member is movable to a contact position contacting the second rotatable member and a spaced position spaced from the second rotatable member; and a controller configured to control an operation of the moving mechanism. The controller moves the separating member from the spaced position to the contact position by the moving mechanism when an image forming process is interrupted in a state in which the separating member is in the spaced position.

### FIELD OF THE INVENTION AND RELATED ART

The present invention relates to an image forming apparatus for forming a toner image on a sheet. Examples of the image forming apparatus may include a copying machine, a facsimile machine, a printer and a multi-function machine having a plurality of functions of these machines.

As a conventional fixing device mounted in the image forming apparatus, a fixing device using a fixing roller and a pressing roller which are rotatable members has been put into practice use. Further, a separation claw is contacted to a surface of the pressing roller in order to separate a recording material (sheet), passed through a nip, from the pressing roller.

However, by sliding with the separation claw, the surface of the pressing roller is roughened, and therefore in an image forming apparatus described in Japanese Laid-Open Patent Application (JP-A) 2009-294453, in the case where an image is formed on thin paper poor in separating property, the separation claw is contacted to the pressing roller surface. On the other hand, in the case where the image is formed on thick paper good in separating property by its own rigidity, the separation claw is spaced from the pressing roller surface.

In the case where a jam (abnormal feeding of the recording material) occurs during the image formation on the thick paper, the following problem can arise.

For example, (a) and (b) of FIG. 13 are schematic views for illustrating a jam clearance space when an A3-sized recording material is removed. As shown in (a) of FIG. 13, when the thin paper causes the jam, the thin paper can be removed in a bunched-up shape. On the other hand, when the thick paper causes the jam, the rigidity is high and therefore it is difficult to remove the thick paper in the bunched-up shape. For that reason, the thick paper can be removed by increasing a space (for removing the recording material, where jam clearance can be performed, positioned upstream of the nip, but the increase in space leads to upsizing of the image forming apparatus and there it cannot be said that the increase in space is preferred countermeasure.

Therefore, as shown in (b) of FIG. 13, it would be considered that the jammed thick paper is sent to a position downstream of the nip with respect to a recording material feeding direction and then is removed at the position downstream of the nip with respect to the recording material feeding direction. However, in the case where the image is formed on the thick paper, the separation claw is spaced from the pressing roller, and therefore the jammed thick paper enters between the pressing roller and the separation claw, so that there is a liability that the jam clearance becomes difficult.

### SUMMARY OF THE INVENTION

According to an aspect of the present invention, there is provided an image forming apparatus comprising: an image forming portion configured to form a toner image on a sheet; a first rotatable member and a second rotatable member which are configured to form a nip therebetween for heating the toner image formed on the sheet by the image forming portion; a separation member configured to separate the sheet in contact with the second rotatable member; a moving mechanism configured to move the separating member so that the separating member is movable to a contact position contacting the second rotatable member and a spaced position spaced from the second rotatable member; and a controller configured to control an operation of the moving mechanism, wherein the controller moves the separating member from the spaced position to the contact position by the moving mechanism when an image forming process is interrupted in a state in which the separating member is in the spaced position.

According to another aspect of the present invention, there is provided an image forming apparatus comprising: an image forming portion configured to form a toner image on a sheet; a first rotatable member and a second rotatable member which are configured to form a nip therebetween for heating the toner image formed on the sheet by the image forming portion; a first moving mechanism configured to move the separating member so that the separating member is movable to a contact position contacting the first rotatable member and a spaced position spaced from the first rotatable member; a separation member configured to separate the sheet in contact with the second rotatable member; a second moving mechanism configured to move the separating member so that the separating member is movable to a contact position contacting the second rotatable member and a spaced position spaced from the second rotatable member; and a controller configured to control an operation of each of the first and second moving mechanisms, wherein the controller moves the separating member from the spaced position to the contact position by the moving mechanism while moving the second rotatable member from the contact position to the spaced position by the first moving mechanism when an image forming process is interrupted in a state in which the separating member is in the spaced position.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an operation control flowchart during jam occurrence in the neighborhood of a nip of a fixing device (fixing apparatus).

FIG. 2 is a schematic illustration of an image forming apparatus in which the fixing device is mounted.

FIG. 3 is a sectional view showing a schematic structure of the fixing device.

FIG. 4 is a sectional view showing a spaced state of an upper separation claw 34 and a lower separation claw 84 of the fixing device.

FIG. 5 is a longitudinal arrangement view of the upper separation claw 34 of the fixing device.

FIG. 6 is an illustration of an arranged state of the upper separation claw 34 and the lower separation claw 84 of the fixing device.

FIG. 7 is an illustration showing a state in which a pulling-out unit D is pulled out from the image forming apparatus in which the fixing device is mounted.

FIG. 8 is an operation control flowchart in image formation of the image forming apparatus in which the fixing device is mounted.

In FIG. 9, (a) and (b) are illustrations each showing a state of a recording material when the recording material jammed in a jam clearance space E is to be removed.

FIG. 10 is an operation control flowchart during jam occurrence in the fixing device.

FIG. 11 is an illustration showing a state (first spaced positions of a pressing roller relative to a fixing roller) between the lower separation claw 84 and an urging (pressing) mechanism 70 of the fixing device.

FIG. 12 is an illustration showing a state (second spaced position of the pressing roller relative to the fixing roller) between the lower separation claw 84 and the urging mechanism 70 of the fixing device.

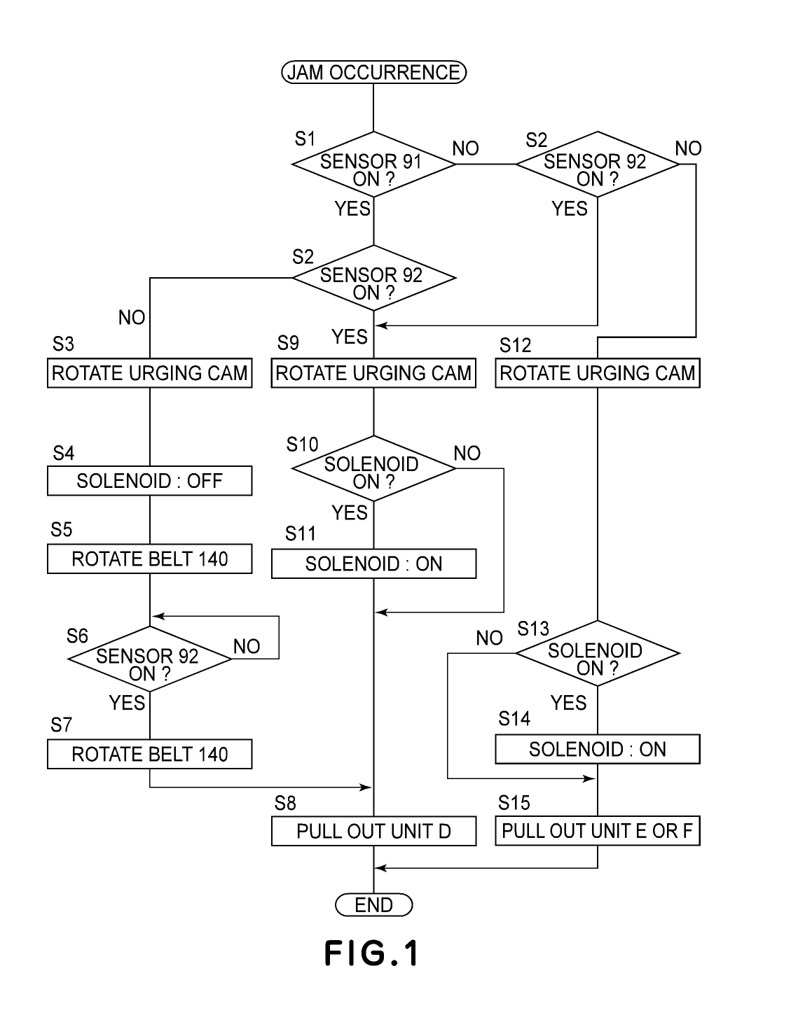

In FIG. 13, (a) and (b) are illustrations each showing a state of an A3-sized recording material when the recording material is to be removed in a conventional fixing device.

### DESCRIPTION OF THE EMBODIMENTS

The present invention will be specifically described based on embodiments below. Although each of these embodiments is an example of the best mode of the present invention, the present invention is not limited by these embodiments.

### First Embodiment

### Image Forming Apparatus

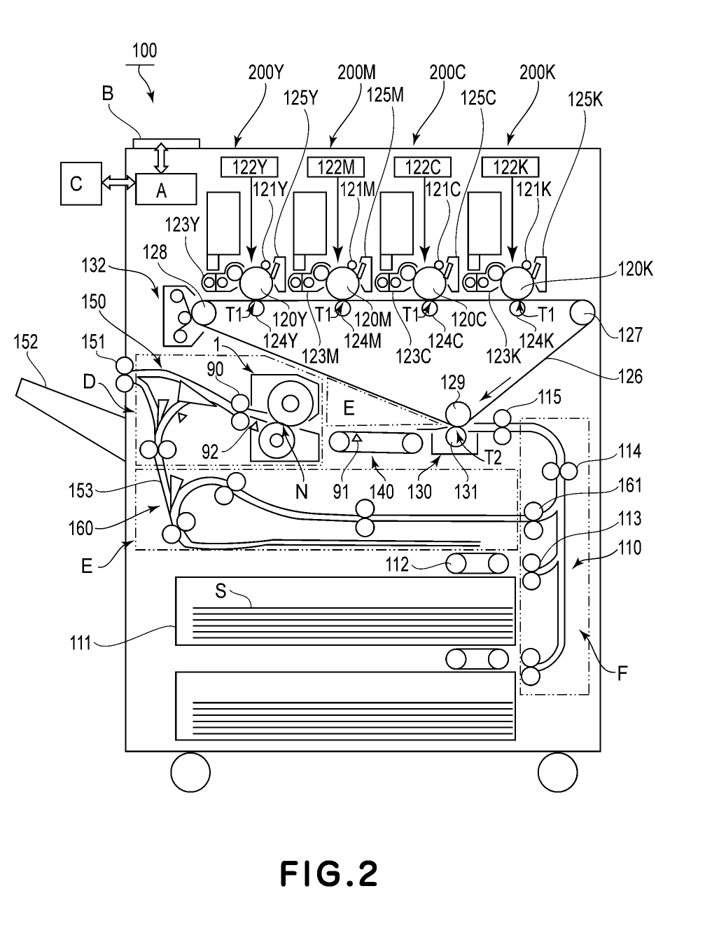

FIG. 2 is a schematic illustration of an image forming apparatus 100 in which a control device for a fixing device in this embodiment of the present invention. This image forming apparatus 100 is a full-color laser beam printer using an electrophotographic type in which an image corresponding to electrical image information inputted from a host device C such as a personal computer or an image reader into a controller (control portion: CPU) A is formed on a recording material (transfer paper) S and then is outputted. The controller A gives and receives various pieces of electrical information between itself and the host device C or an operating display portion (operating portion) B, and effects integrated control of an image forming operation in accordance with a predetermined control program or a reference table.

As shown in FIG. 2, in an apparatus main assembly of the image forming apparatus 100, e.g., image forming stations 200Y, 200M, 200C and 200K corresponding to colors of Y (yellow), M (magenta), C (cyan) and K (black), respectively, are provided in series as image forming portions. That is, the image forming apparatus 100 employs a tandem type in which processes until visualization for the respective colors are performed in parallel. In the following, in order to prevent complicated description, the image forming stations for Y, M, C and K will be collectively described as the image forming station 200. This is true for also the following process means. Further, the order of the arrangement of the image forming stations for the colors of Y, M, C and K is not limited to the above order.

Each image forming station 200 includes the following process means. That is, corresponding to each of the colors of Y, M, C and K, an image bearing member 120 for bearing an electrostatic latent image on a surface thereof, a primary charging device 121, an exposure device 123 and a cleaning device 124 are provided. The primary charging device 121 electrically charging the surface of the corresponding image bearing member 120 uniformly by being supplied with a charging bias voltage of a set potential. Then, the surface of the image bearing member 120 is exposed to light by the exposure device 122, so that the electrostatic latent image is formed. The electrostatic latent image is developed with a toner by the developing device 124 into a visualized image as a toner image.

The toner images formed and carried on the respective image bearing members 120 are successively primary-transferred superposedly onto an intermediary transfer belt 126, which is an endless belt, at a primary transfer nip T1 of a primary transfer device 125. The intermediary transfer belt 126 is extended around and supported by a driving roller 127, a tension roller 128 and an opposing roller 129, and is driven by the driving roller 127, thus being rotated in the counterclockwise direction indicated by an arrow.

A secondary transfer roller 131 provided in a secondary transfer device 130 press-contact the intermediary transfer belt 126 supported by the opposing roller 129 from the inside of the intermediary transfer belt 126, so that a secondary transfer nip T2 between the secondary transfer roller 131 and the intermediary transfer belt 126. Then, the toner images for all the colors of Y, M, C and K, which are primary-transferred on the intermediary transfer belt 126 are then collectively secondary-transferred onto the recording material S at the secondary transfer nip T2.

A belt cleaning device 132 rubs the intermediary transfer belt 126 with a cleaning web, and removes a transfer toner, paper powder and the like which remain on the surface of the intermediary transfer belt 126 passed through the secondary transfer nip T2.

On the other hand, a recording material feeding device 110 separates the recording material (sheet) S, one by one by a separating device 113, pulled out from a recording material accommodating cassette 111 by a pick-up roller 112, and then sends the recording material S toward a registration roller pair 115. The registration roller pair 105 receives the recording material S in a rest state and is in stand-by, and then sends the recording material S toward the secondary transfer nip T2 by timing the recording material S to the toner images on the intermediary transfer belt 126.

The recording material S carrying the toner images transferred at the secondary transfer nip T2 is fed to a fixing device (fixing apparatus) 1 by a belt feeding device 140 as a feeding mechanism. In the fixing device 1, at a fixing nip N, the recording material S is sandwiched, and heat and pressure are applied to the toner images, so that the toner images are fixed on the recording material S. The recording material S sent from the fixing device 1 after an end of a fixing process is fed by a feeding roller pair 90 toward a discharging path 150 or a feeding path 160 for double-side printing.

In the case of an operation in a one-side printing, the recording material S on which the toner images are fixed is fed to the discharging path 150 and then is discharged onto a discharge tray 152 by a discharging roller pair 151, thus being stacked on the discharge tray 152.

In the case of the double-side printing, the recording material S on which the toner images are fixed at one surface (the front surface) is fed to a reversing path 153, and is, after being subjected to switchback, sent to the feeding path 160 for the double-side printing, and then is in stand-by at a feeding roller pair 161 for the double-side printing. Thereafter, the recording material S is sent again to the secondary transfer nip T2 by the registration roller pair 115, and then the toner images are secondary-transferred onto also the other surface (the back surface), and thereafter the toner images (which are not yet fixed) are fixed by the fixing device 1.

In the above-described manner, in the apparatus main assembly, a series of image forming processes such as charging, exposure, development, transfer and fixing is executed, so that the color toner image is formed on the recording material S and then is discharged. In the case of a monochromatic image forming apparatus, only the image bearing member for black (K) exists, and the toner image formed on the image bearing member is transferred onto the recording material S by the transfer device.

### (Control Device for Fixing Device)

In this embodiment, a controller A as a control for controlling the fixing device as an image heating apparatus includes a control portion for controlling operations of first and second moving mechanisms described later. Such a controller A includes not only the case where the controller A is incorporated in the image forming apparatus but also the case where the controller A is provided in the fixing device when the fixing device is used, as a dedicated machine, independently of the image forming portion.

In the former case, the image forming apparatus includes the image forming portion for forming the toner image on the recording material, a fixing portion (fixing device) for fixing the toner image and the control device for the fixing device. In the latter case, the fixing device includes the fixing portion for fixing the toner image formed on the recording material, and the control device for the fixing portion (fixing device).

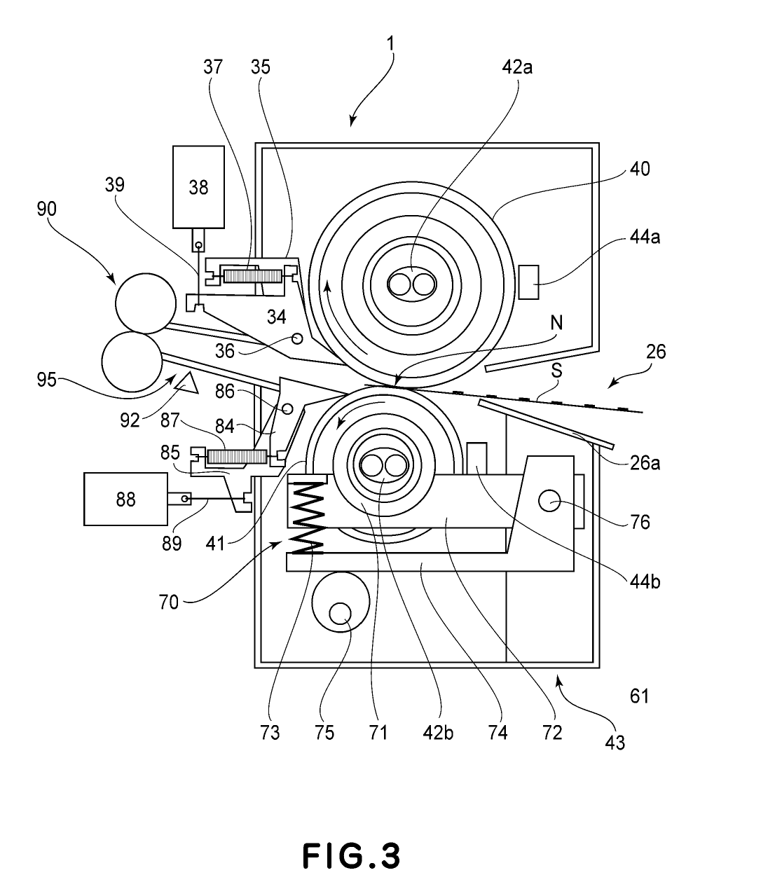

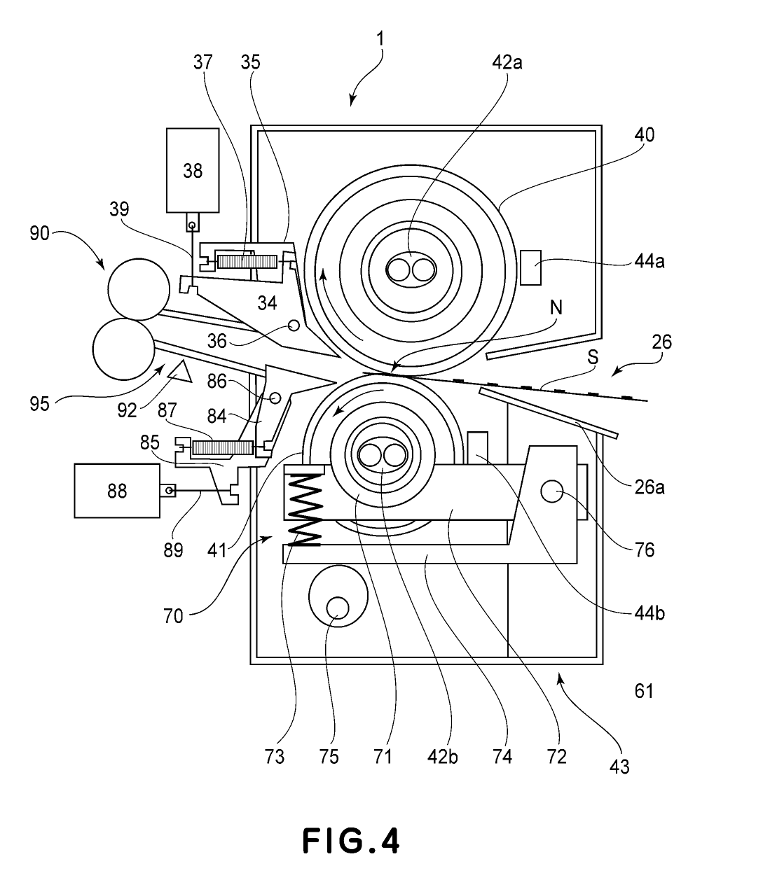

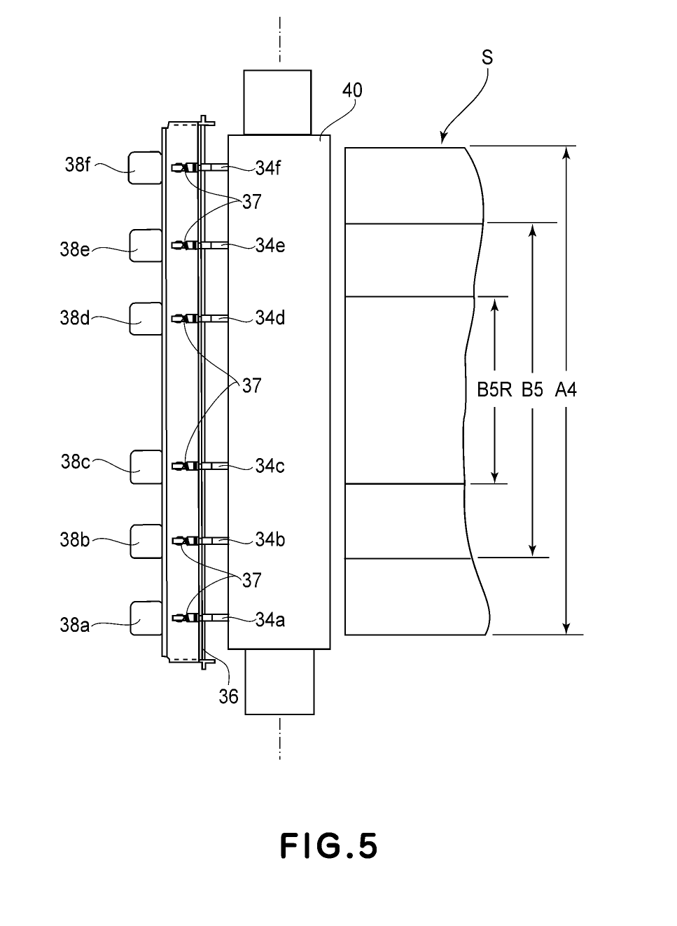

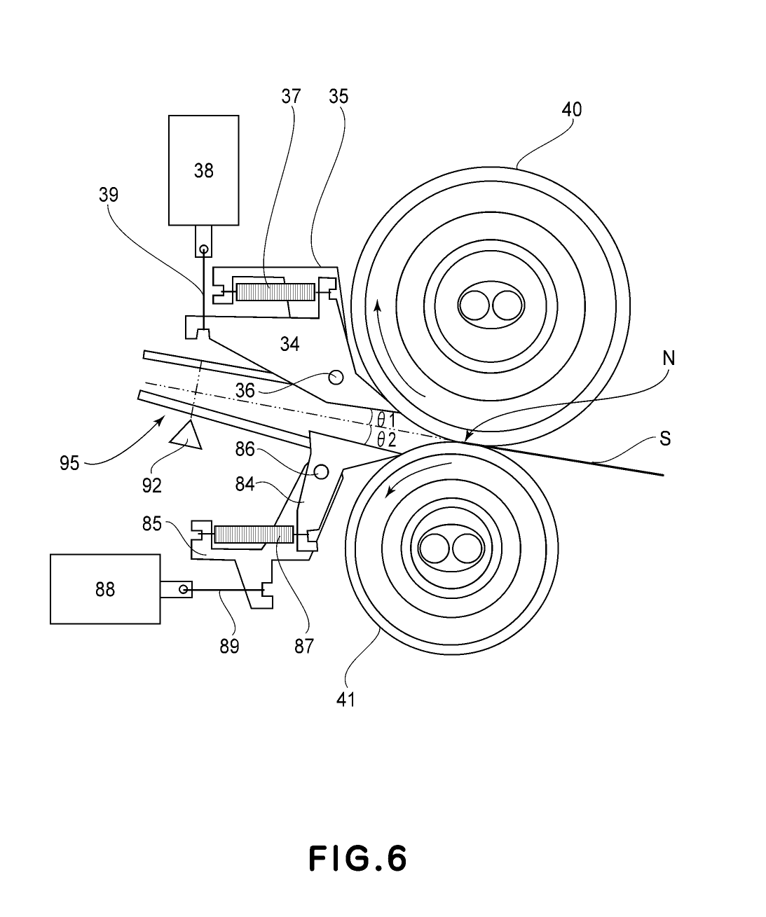

FIG. 3 is a sectional view showing a schematic structure of the fixing device 1 to be controlled by the control device in this embodiment. FIG. 4 is a sectional view showing a retracted (spaced) state of an upper separation claw 34 and a lower separation claw 84, which are separating means, of the fixing device 1. FIG. 5 is a longitudinal arrangement view of the upper separation claw 34 of the fixing device 1. FIG. 6 is an illustration of an arranged state of the upper separation claw 34 and the lower separation claw 84 of the fixing device 1.

This fixing device 1 is in an image heating apparatus of a heating roller pair type, and includes a fixing roller (image rotatable member) 40 and a pressing roller (second rotatable member) 41 as a pair of rotatable members for forming the fixing nip N in contact with each other to heat the toner image on the recording material. The pressing roller 41 is provided in a lower side relative to the fixing roller 40 with respect to a direction of gravitation.

In this embodiment, the fixing roller 40 includes, as a core metal, a hollow pipe formed of Al in an outer diameter of 66 mm, and on the core metal, a silicone rubber elastic layer of 20° in rubber hardness (JIS-A, under a load of 1 kg) is molded in a thickness of 2.0 mm. The surface of the elastic layer is coated with a 50 μm-thick fluorine-containing resin layer as a surface parting layer, so that an elastic roller of 70 mm in outer diameter is prepared as the fixing roller 40. The surface parting layer is a fluorine-containing resin tube and is constituted in general by PFA resin (a copolymer of tetrafluoroethylene resin and perfluoroalkoxyethylene resin), PTEF (tetrafluoroethylene resin) or the like.

Further, similarly as in the case of the fixing roller 40, also the pressing roller 41 includes, as a core metal, a hollow pipe formed of Al in an outer diameter of 66 mm, and on the core metal, a silicone rubber elastic layer of 20° in rubber hardness (JIS-A, under a load of 1 kg) is molded in a thickness of 2.0 mm. The surface of the elastic layer is coated with a 50 μm-thick fluorine-containing resin layer as a surface parting layer, so that an elastic roller of 70 mm in outer diameter is prepared as the pressing roller 41. By combining the fixing roller 40 and the pressing roller 41 which have the above-described constitutions, a parting property from the toner is further enhanced.

The fixing roller 40 and the pressing roller 41 are vertically disposed, with respect to the direction of gravitation, in parallel between opposing side plates (not shown) of a device frame 43, and are shaft-supported and held rotatably. Further, the fixing roller 40 and the pressing roller 41 are press-contacted to each other, by an urging mechanism (pressing mechanism) 70 (first moving mechanism) for moving the rotates toward and away from each other, in a contact state during the fixing at a total pressure of about 980N (100 kg) against elasticity of the elastic layers of the rollers. As a result, between the fixing roller 40 and the pressing roller 41, the fixing nip N having a predetermined width with respect to a recording material feeding direction (sheet feeding direction) is formed.

The core metal of the fixing roller 40 is provided coaxially with a drive input gear (not shown). A driving force is transmitted from a driving means M1 (not shown) to this drive input gear, so that the fixing roller 40 is rotationally driven at a predetermined speed in the clockwise direction indicated by an arrow in FIG. 3. The pressing roller 41 is rotated by the rotational drive of the fixing roller 40 in the counterclockwise direction indicated by an arrow. In this embodiment, a driving speed of the fixing roller 40 is se so that a feeding speed of the recording material S is 500 mm/sec.

Inside the core metal of the fixing roller 40, a halogen heater 42a as a heat generating means is inserted and disposed. Further, also inside the core metal of the pressing roller 41, a halogen heater 42b as the heat generating means is inserted and disposed, so that the halogen heaters 42a and 42b generate heat to heat the fixing roller 40 and the pressing roller 41, respectively, from the inside. Further, a thermistor 44a as a temperature detecting means for detecting a temperature of the fixing roller 40 and a thermistor 44b as the temperature detecting means for detecting a temperature of the pressing roller 41 are provided in contact with outer surfaces of the fixing roller 40 and the pressing roller 41, respectively.

In a recording material exit side (downstream side) of the fixing nip Nm the upper separation claw 34 contacting the fixing roller 40 and the lower separation claw 84 contacting the pressing roller 41 are swingably provided. The upper separation claw 34 and the lower separation claw 84 are the separating members for separating the recording material from the fixing roller 40 and the pressing roller 41.

The controller A turns on not only the driving means M1 but also the halogen heaters 42a and 42b at predetermined control timing. Then, pieces of temperature detection information (electrical information on the temperatures of the fixing roller 40 and the pressing roller 41) of the thermistors 44a and 44b are inputted into the controller A. The controller A contacts electric power to be supplied to the halogen heaters 42a and 42b s that pieces of the temperature detection information inputted from the thermistors 44a and 44b are kept at piece of temperature information corresponding to predetermined set temperatures (fixing temperatures), respectively.

In this embodiment, the controller A temperature controls the fixing roller 40 and the pressing roller 41 so that both of the temperatures of the fixing roller 40 and the pressing roller 41 are increased to about 180° C. which is a fixing temperature, and are kept at the substantially constant level. In this state, the recording material S carrying the toner image is introduced into the fixing device 1 through an entrance 26, and then is guided by an entrance-side guide 26a to enter the fixing nip N, so that the recording material S is nipped and fed through the fixing nip N to be heated and pressed (an heating operation by the fixing roller 40 and the pressing roller 41). As a result, the toner image is fixed as a fixed image on the recording material S.

The recording material S passed through the fixing nip N is separated from the fixing roller 40 and the pressing roller 41 by the upper separation claw 34 and the lower separation claw 84, and then is guided by a feeding guide (exit-side guide) 95, that the recording material S comes out of the fixing device 1 and then is further fed by the feeding roller pair 90.

### 1) Urging Mechanism 70

The urging (pressing) mechanism 70 shaft-supports rotatably the pressing roller 41 by bearings 71 at both end portions thereof, and includes an urging arm 72 for urging the pressing roller 41 toward the fixing roller 40 while supporting the bearings 71. The urging arm 72 is provided with an urging spring 73 which is locked at one end, and by the urging spring 73, the pressing roller 41 is urged in a press-contact direction by being pressed against the fixing roller 40. Further, the urging mechanism 70 includes an urging lever 74 by which the urging spring 73 is locked at the other end, and the urging lever 74 is shaft-supported by the device frame 43 so that the urging spring 73 is compressed to rotatably urge the pressing roller 41 against the fixing roller 40 in the press-contact direction.

The urging lever 74 is provided with an urging cam 75 thereunder. When the urging lever 74 is rotated about a supporting shaft 76 as a rotation center in the clockwise direction in FIG. 3 by rotation of the urging cam 75, the urging spring 73 is compressed. An elastically repelling force of the compressed urging spring 73 is exerted on the urging arm 72, whereby an urging force for urging the pressing roller 41 toward the fixing roller 40 in an urging (press-contact) direction is generated. By such a mechanism, the fixing roller 40 and the pressing roller 41 are placed in the contact state, so that the fixing nip N is formed between press-contact surfaces of these rollers.

### 2) Contact/Restraction (Spacing) Mechanism for Upper Separation Claw 34 and Lower Separation Claw 84

Next, with reference to FIGS. 3 and 4, structures of the upper separation claw 34 and the lower separation claw 84 will be described. The upper separation claw 34 is disposed in contact with the fixing roller 40, and the lower separation claw 84 is disposed in contact with the pressing roller 41. The recording material S passed through the fixing nip N is separated from the fixing roller 40 and the pressing roller 41 by the upper separation claw 34 and the lower separation claw 84, and then comes out of the fixing device 1, so that the recording material S is further fed by the feeding roller pair 90.

The upper separation claw 34 will be described specifically. A plurality of upper separation claws 34 are provided along a longitudinal direction of the fixing roller 40. The upper separation claws 34 are supported rotatably about a supporting shaft 36 as a center, and is contacted to the fixing roller 40 at a predetermined pressure of 0.049 N (5 gf) by a spring 37. In a rear end side of each of the upper separation claws 34, a wire 39 connected to a solenoid 38 as a driving means to be turned on and off the controller A is mounted. When the solenoid 38 is turned on, the upper separation claw 34 is pulled up against the spring 37 in the rear side.

As a result, the upper separation claw 34 is rotated about the supporting shaft 36 as the center in a spaced direction from the fixing roller 40. That is, the upper separation claw 34 is separated from a separating position, where a separating operation is to be performed by turning the solenoid 38 on. A distance at that time between the fixing roller 40 and a leading end of the upper separation claw 34 is set so as to be 1 mm to 1.5 mm during the heating of the fixing roller 40. This state is shown in FIG. 4.

When the solenoid 38 is turned off, the upper separation claw 34 is contacted to the fixing roller 40 (state of FIG. 3). As the solenoid 38, a latching solenoid is used, and through which a current passes when the latching solenoid is turned on and off. After the current passes through the solenoid, even when the current is not passed through the solenoid, the state can be maintained by a magnetic force.

The solenoid 38 may be provided for each of the upper separation claws 34, and a mounting and dismounting operation of all the upper separation claws 34 may also be performed by a single solenoid 38. As a mounting and dismounting mechanism of the upper separation claw 34, a constitution in which the upper separation claw 34 is rotated about the supporting shaft 36 is described, but a constitution such that the upper separation claw 34 is slid together with a separation claw supporting table 35 may also be employed.

The upper separation claws 34 are appropriately disposed correspondingly to various sizes (sheet sizes) of the recording material S with respect to a longitudinal direction of the fixing roller 40. FIG. 5 shows an example of arrangement of the upper separation claws 34 in the case of a center feeding (center reference feeding) in which a recording material feeding center is in a center position with respect to the longitudinal direction. The upper separation claws 34a to 34f are disposed correspondingly to an A4-sized recording material, and the upper separation claws 34b to 34e are disposed correspondingly to a B5-sized recording material. Further, the upper separation claws 34c and 34d are disposed correspondingly to a B5R-sized recording material, and are contacted to the fixing roller 40 by the springs 37.

Also, the lower separation claw 84 has the same structure as the upper separation claw 34. A plurality of lower separation claws 84 are provided along a longitudinal direction of the pressing roller 41. That is, the lower separation claws 84 are supported rotatably about a supporting shaft 86 as a center, and is contacted to the pressing roller 41 at a predetermined pressure of 0.049 N (5 gf) by a spring 87. In a rear end side of each of the lower separation claws 84, a wire 89 connected to a solenoid 88 (second moving means) as a driving means to be turned on and off the controller A is mounted. When the solenoid 88 is turned on, the lower separation claw 84 is pulled down against the spring 87 in the rear side.

As a result, the lower separation claw 84 is rotated about the supporting shaft 86 as the center in a spaced direction from the pressing roller 41. That is, the lower separation claw 84 is retracted (moved) to a retracted position (retracted (spaced) from the pressing roller 41) spaced from a separating position, where a separating operation is to be performed by turning the solenoid 88 capable of moving the lower separation claw 84 toward and away from the pressing roller 41. A distance at that time between the pressing roller 41 and a leading end of the lower separation claw 84 is set so as to be 1 mm to 1.5 mm during the heating of the fixing roller 40. This state is shown in FIG. 4. When the solenoid 88 is turned off, the lower separation claw 84 is contacted to the pressing roller 41 (state of FIG. 3). As the solenoid 88, a latching solenoid is used,

### 3) Shape of Upper Separation Claw 34 and Lower Separation Claw 84

Next, with reference to FIG. 6, shapes of the upper separation claw 34 and the lower separation claw 84 will be described. The upper separation claw 34 and the lower separation claw 84 are contacted to the fixing roller 40 and the pressing roller 41, respectively, at a light pressure (0.049 N (5 gf) in this embodiment). When an angle θ1 formed between a claw edge line 34a of the upper separation claw 34 and a discharging direction of the recording material to be discharged through the fixing nip is large, there is a possibility that the upper separation claw 34 is pushed and rotated by the recording material to be discharged. Further, also in the case where an angle θ2 formed between a claw edge line 84b of the lower separation claw 84 and the discharging direction of the recording material to be discharged through the fixing nip is large, there is a possibility that the lower separation claw 84 is pushed and rotated by the recording material to be discharged.

As a result of an experiment, it was found that the upper separation claw 34 is not rotated when the angle θ1 formed between the claw edge line 34a and the recording material discharging direction is 30° or less. Further, similarly, it was found that also the lower separation claw 84 is not rotated when the angle θ2 formed between the claw edge line 84a and the recording material discharging direction is 30° or less. Accordingly, in this embodiment, the angle θ1 for the upper separation claw 34 is set at 10° or less. Further, the angle θ2 for the lower separation claw 84 is set at 10° or less. In this way, the shapes of the upper separation claw 34 and the lower separation claw 84 is determined.

### 4) Reason why Separation Claws are Provided

The reason why the upper separation claw 34 is placed in the separating position and is contacted to the fixing roller 40 in this embodiment is as follows. First, when the unfixed toner on the recording material is crushed at the fixing nip N, the toner is deposited on the fixing roller surface and therefore the recording material S is wound around the fixing roller 40 without being separated from the fixing roller 40, and therefore it is preferable that this phenomenon is eliminated.

In a state in which the recording material S is wound around the fixing roller 40 without being separated from the fixing roller 40, the recording material S is still nipped and fed at the fixing nip N, and therefore due to rigidity of the recording material, a peeling force acts on the recording material in a direction in which the recording material moves away from the fixing roller 40.

Then, when the peeling force due to the rigidity of the recording material becomes larger than adhesion between the fixing roller 40 and the recording material, the recording material separates from the fixing roller 40 and is not wound around the fixing roller 40. The rigidity of the recording material is influenced by a thickness of the recording material, so that the rigidity is small for thin paper and is increased with an increasing thickness of the paper. Therefore, the thin paper is liable to wind around the fixing roller 40, and the thick paper does not readily wind around the fixing roller 40. When the recording material does not wind around the fixing roller 40, there is no need to peel the recording material from the fixing roller 40 by the upper separation claw 34, and therefore it becomes possible that the upper separation claw 34 can be placed in a state (retracted state) retracted (spaced) from the fixing roller surface.

Under a condition in this embodiment, when the recording material is plain paper and has a basis weight of 100 gsm, the recording material is feedable without relying on the upper separation claw 34. Therefore, in this embodiment, in order to prevent the surface of the fixing roller 40 from being rubbed with the upper separation claw 34, the upper separation claw 34 is contacted to the fixing roller 40 when the plain paper has the basis weight of 120 gsm or less. In the case where the plain paper has the basis weight of 120 gsm or more, the upper separation claw 34 is retracted (spaced) from the fixing roller 40.

Similarly, the reason why the lower separation claw 84 is placed in the separating position and is contacted to the pressing roller 41 in this embodiment is as follows. First, when the image is formed on both surfaces of the recording material, due to a difference in toner amount on the image between the fixing roller 40 and the pressing roller 41, the recording material wound around the fixing roller 40 in some cases, and therefore it is preferable that this phenomenon is eliminated.

Also with respect to the pressing roller 41 similarly as in the case of the fixing roller 40, the thin paper is liable to wind around the pressing roller 41, and the thick paper does not readily wind around the pressing roller 41. When the recording material does not wind around the pressing roller 41, there is no need to peel the recording material from the pressing roller 41 by the lower separation claw 84, and therefore it becomes possible that the lower separation claw 84 can be placed in a state retracted (spaced) from the pressing roller surface. Therefore, under a condition in this embodiment, when the recording material is plain paper and exceeds 100 gsm in basis weight, the recording material is feedable without relying on the lower separation claw 84.

In this embodiment, in order to prevent the surface of the pressing roller 41 from being roughened by the lower separation claw 84, the lower separation claw 84 is contacted to the pressing roller 41 only in the case where the plain paper has the basis weight which does not exceed 120 gsm or less. In the case where the plain paper has the basis weight which does not exceed 120 gsm, the lower separation claw 84 is retracted (spaced) from the pressing roller 41.

In this embodiment, the contact conditions for the upper separation claw 34 and the lower separation claw 84 are set as the same basis weight, but may also be set as different basis weights.

### 5) Operation Control During Fixing in Image Forming Apparatus 100

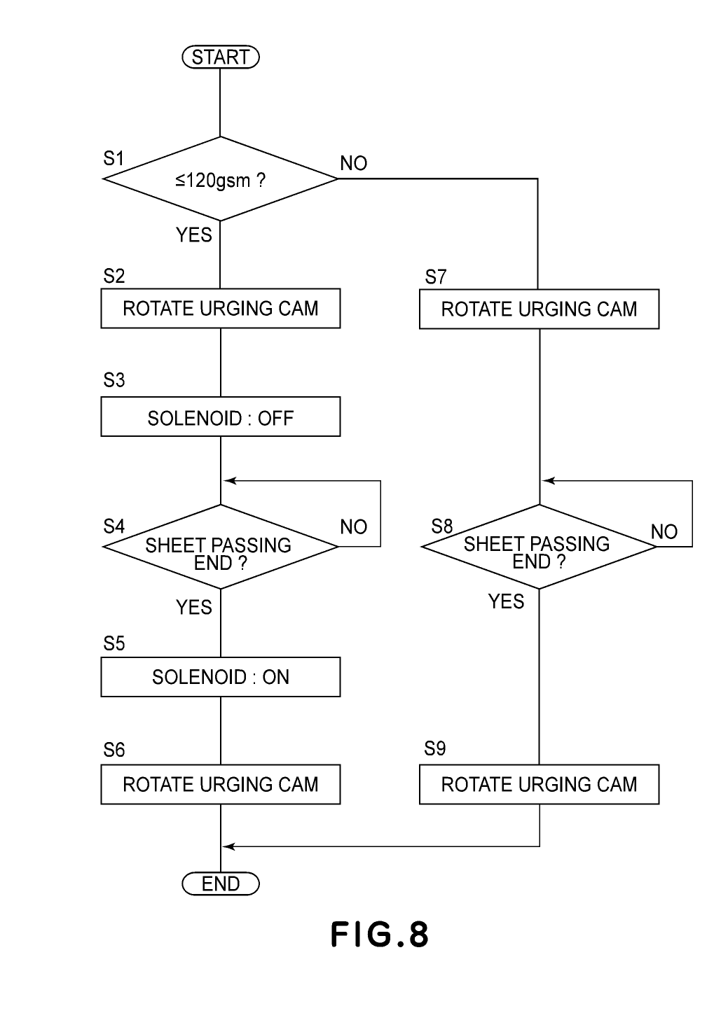

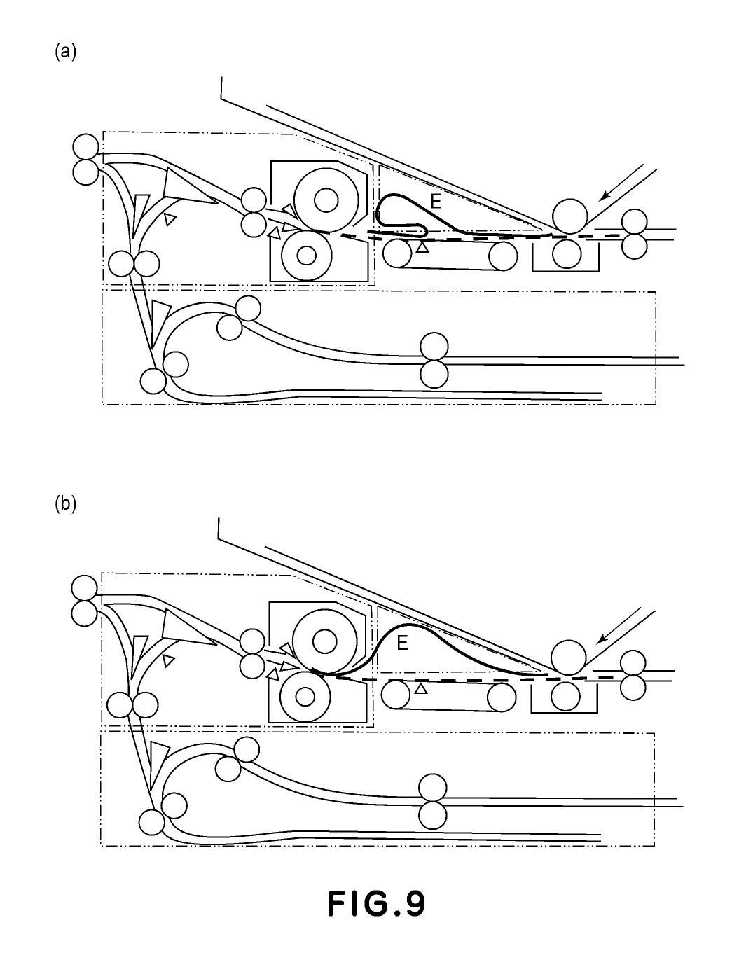

Next, by using a flowchart of FIG. 8, the image forming process in the image forming apparatus 100 will be described. First, in the case of printout, a user inputs a recording material condition and a printout sheet number through an operating display portion B (FIG. 2), thus setting a printout condition. Then, a copy start key (not shown) is turned on, so that the printout is started.

Then, the controller A as a control means effects the following control as an operation in a control mode (second control mode) in the fixing process. That is, the pressing roller 41 is placed in the contact state to the fixing roller 40, and in the case where the basis weight of the recording material exceeds a threshold, the lower separation claw 84 is placed in the retracted (spaced) state from the pressing roller 40. On the other hand, in the case where the basis weight of the recording material does not exceed the threshold, the lower separation claw 84 is placed in the contact state to the pressing roller 41. Further, in this embodiment, similarly as the contact and separation (spacing) of the lower separation claw 84 relative to the pressing roller 41, the contact and separation of the upper separation claw 34 relative to the fixing roller 40 is simultaneously carried out.

A specific flow is as follows in the case where it is discriminated that the basis weight of the recording material used does not exceed the threshold (120 gsm in this embodiment) from the value inputted by the user. That is, when the printing is started and thus the image forming process is started, in the fixing device 1, the pressing roller 41 is press-contacted to the fixing roller 40 by the urging mechanism 70, and then the fixing operation is started (S2). Then, claw-spacing solenoids 38 and 88 are turned off (S3). As a result, the lower separation claw is contacted to the pressing roller, and the upper separation claw is contacted to the fixing roller.

Thereafter, the print out of a set number of sheets is ended, sheet passing is ended (S4). When the sheet passing is ended, the claw-spacing solenoids 38 and 88 are turned on, so that the upper separation claw 34 and the lower separation claw 84 are retracted from the fixing roller 40 and the pressing roller 41 (S5), and the pressing roller 41 is spaced from the fixing roller 40 by the urging mechanism 70 (S6).

Further, the control A as the control portion starts the fixing operation when the image forming process is started in the case where the basis weight of the recording material S to be subjected to the fixing exceeds the threshold (120 gsm in this embodiment) (S7). Then, in the fixing device 1, the pressing roller 41 is press-contacted to the fixing roller 40 by the urging mechanism 70. The image forming process is performed in the retracted state of the upper separation claw 34 and the lower separation claw 84, and when the printing of the set number of sheets is ended, the image forming process is ended (S8). When the image forming process is ended, the pressing roller 41 is spaced from the fixing roller 40 by the urging mechanism 70 (S9).

In this way, in this embodiment, depending on the basis weight (paper thickness) of the recording material subjected to the image forming process, the turning-on/off of the claw-spacing solenoids 38 and 88 (retraction of the separation claws from the rollers/contact of the separation claws to the rollers) is controlled.

### 6) Operation Control During Jam Occurrence in Image Forming Apparatus 100

### 6-1) Contact/Retraction (Spacing) Operation of Upper Separation Claw 34 and Lower Separation Claw 34 During Occurrence of Jam

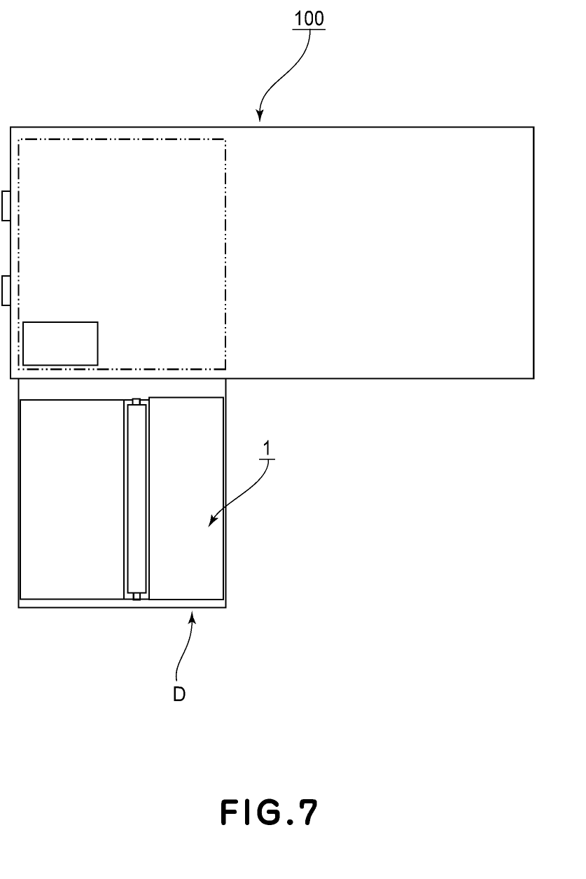

In this embodiment, as shown in FIG. 2, a pulling-out unit D including the fixing device 1 and a discharging path 150 as a unit is constituted so as to be pullable out toward the front surface of the image forming apparatus main assembly. When the jam occurs in the neighborhood of the fixing nip N, the pulling-out unit D is pulled out in the front surface side of the image forming apparatus 100 as shown in FIG. 7, and then the jammed recording material is removed. The reason why jam clearance is made after the pulling-out unit D is pulled out is that, e.g., when the recording material having the basis weight exceeding 250 gsm causes the jam in the neighborhood of the fixing nip N, it is difficult to crumple the recording material in the jam clearance space E since the rigidity of the recording material is large.

Further, the reason is also that when the recording material is forcedly pulled out from the jam clearance space E shown in FIG. 2 and is taken out from the front surface side of the image forming apparatus 100, there is possibility that the fixing roller 40 and the pressing roller 41 are damaged by the edge of the recording material. Accordingly, when jam occurs in the neighborhood of the fixing nip N, the fixing roller 40 and the pressing roller 41 are moved from the contact position to the spaced position (spaced state) by the urging mechanism 70. Then, the claw-spacing solenoids 38 and 88 are turned off irrespective of the basis weight of the recording material, so that the upper separation claw 34 is contacted to the fixing roller 40 so as to create the contact state, and the lower separation claw 84 is contacted to the pressing roller 41. That is, the separation claws are moved from the retracted position to the separating position so as to create the contact state.

As a result, a gap formed between the pressing roller 41 and the feeding guide 95 disposed downstream of the fixing nip N is blocked with the lower separation claw 84, so that the jammed recording material (stagnated in the fixing device) can be placed in a state in which the recording material is feedable toward a downstream side with respect to the feeding direction. Thereafter, the controller A rotates the feeding belt 140, so that the jammed recording material is fed until the feeding sensor 91 detects a leading end of the recording material. Then, the pulling-out unit D is pulled out to the front surface side of the image forming apparatus, and then the jammed recording material is removed.

In this embodiment, the feeding belt 140 is rotated, so that the jammed recording material is fed until the feeding sensor 91 detects the leading end of the recording material, but after the jammed recording material is sent by a user with hand toward a position downstream of the nip with respect to the recording material feeding direction, the user may also pulled out the pulling-out unit D to the image forming apparatus front surface side and then removes the jammed recording material.

### 6-2) Flowchart During Jam Occurrence

Next, by using the schematic illustration of the image forming apparatus 100 of FIG. 2 and the flowchart of FIG. 8, an operation flow when the jam occurs during the printing in this embodiment will be described. During the printing, when the jam occurs in the neighborhood of the fixing nip N, the controller A as the control portion checks the state of each of the feeding sensors 91 and 92 provided in the image forming apparatus 100 (S1, S2).

The presence or absence of the jam occurrence in the neighborhood of the fixing device is discriminated by monitoring the feeding sensors 91 and 92 by the control portion. Specifically, the image forming process is started and the feeding sensor 91 detects the recording material, and then in the case where the feeding sensor 92 does not detect the recording material from the detection time until a predetermined time elapses from the detection time, the state is regarded as a jam occurrence state, and the image forming operation is interrupted. In this way, the control portion discriminates the presence or absence of the jam occurrence by monitoring detecting results of the feeding sensors 91 and 92. Then, when the jam clearance is ended, the image forming process is resumed. That is, in the case where the image forming process for the thick paper is interrupted, by moving the lower separation claw 84 from the spaced position to the contact position while moving the pressing roller 41 from the contact position to the spaced position, the jammed thick paper is fed to a position downstream of the nip N. Then, the jam clearance (removal of the stagnated thick paper) is made by the user, and when the jam clearance (insertion of the pulling-out unit D into the image forming apparatus and a closing operation of an openable door) is ended, in order to resume the image forming process, the lower separation claw 84 is moved from the contact position to the spaced position. Further, with the resumption of the image forming process, at the time when the recording material approaches the nip N, the pressing roller 41 is contacted to the fixing roller 40.

(A) Case where Feeding Sensor 91 Detects Recording Material and Feeding Sensor 92 does not Detect Jammed Recording Material

In this case, the controller A discriminates that the recording material leading end position is located upstream of the fixing nip N. Then the controller A as the control means effects the following control as an operation in a first control mode. That is, first, the pressing roller 41 is spaced from the fixing roller 40 by the urging mechanism 70 (S3). Then, the claw-spacing solenoids 38 and 88 are turned off irrespective of the recording material basis weight, so that the upper separation claw 34 and the lower separation claw 84 are contacted to the fixing roller 40 and the pressing roller 41 (S4).

Thereafter, the feeding belt 140 is rotated (S5), and when the feeding sensor 92 detects the recording material leading end (S6), the rotation of the feeding belt 140 is stopped (S7). In this state, guidance is displayed at the separating display portion B so that the user pulls out the pulling-out unit D to the front surface side of the image forming apparatus 100 and then removes the jammed recording material (S8).

(B) Case where Feeding Sensors 91 and 92 Detect Jammed Recording Material

In this case, the controller A discriminates that the recording material leading end position is located downstream of the fixing nip N. Then, the controller A spaces the pressing roller 41 from the fixing roller 40 by the urging mechanism 70 (S9). Then, in the case where the upper separation claw 34 and the lower separation claw 84 are contacted to the fixing roller 40 and the pressing roller 41 (S10), the claw-spacing solenoids 38 and 88 are turned on, so that the upper separation claw 34 and the lower separation claw 84 are spaced from the fixing roller 40 and the pressing roller 41 (S11). In this state, guidance is displayed at the separating display portion B so that the user pulls out the pulling-out unit D to the front surface side of the image forming apparatus 100 and then removes the jammed recording material (S8).

(C) Case where Feeding Sensor 91 does not Detect Recording Material but Feeding Sensor 92 Detects Jammed Recording Material

In this case, the controller A discriminates that the recording material leading end position is located downstream of the fixing nip N. Then, the controller A spaces the pressing roller 41 from the fixing roller 40 by the urging mechanism 70 (S9). Then, in the case where the upper separation claw 34 and the lower separation claw 84 and contacted to the fixing roller 40 and the pressing roller 41 (S10), the claw-spacing solenoids 38 and 88 are turned on, so that the upper separation claw 34 and the lower separation claw 84 are spaced from the fixing roller 40 and the pressing roller 41 (S11). In this state, guidance is displayed at the separating display portion B so that the user pulls out the pulling-out unit D to the front surface side of the image forming apparatus 100 and then removes the jammed recording material (S8).

(D) Case where Feeding Sensors 91 and 92 do not Detect Jammed Recording Material

In this case, the controller A discriminates that the recording material leading end position is not in the neighborhood of the pressing roller 41 from the fixing roller 40 by the urging mechanism 70 (S12). Then, in the case where the upper separation claw 34 and the lower separation claw 84 are contacted to the fixing roller 40 and the pressing roller 41 (S13), the claw-spacing solenoids 38 and 88 are turned on, so that the upper separation claw 34 and the lower separation claw 84 are retracted (spaced) from the fixing roller 40 and the pressing roller 41 (S14). In this state, guidance is displayed at the separating display portion B so that the user pulls out another pulling-out unit E or F of the image forming apparatus 100 and then removes the jammed recording material (S17).

### Effect of this Embodiment

As described above, in the case where the jam occurs in the neighborhood of the fixing nip N, particularly in the case where the jam occurs upstream of the fixing nip N, the controller A spaces the fixing roller 40 and the pressing roller 41 from each other irrespective of the basis weight of the recording material. Further, irrespective of the recording material basis weight, the lower separation claw 84 is contacted to the pressing roller 41 to close the gap between the pressing roller 41 and the lower separation claw 84. Further, the upper separation claw 34 is contacted to the fixing roller 40 to close the gap between the fixing roller 40 and the upper separation claw 34.

As a result, even when the jammed recording material is sent into the fixing nip N, the recording material can be moved downstream with respect to the feeding direction without being caught by entering the gap with the upper separation claw 34 or the lower separation claw 84 at the leading end thereof. In this state, the pulling-out unit D is pulled out to the front surface of the image forming apparatus 100, and then the jammed recording material is removed. As a result, irrespective of the recording material basis weight, the jam clearance of the recording material having a large rigidity, particularly having the basis weight exceeding 250 gsm becomes easy. For this reason, the fixing roller 40 and the pressing roller 41 can be prevented from being damaged by the jam clearance.

In this way, according to this embodiment, when abnormal feeding of the recording material generates in the upstream side of the nip with respect to the recording material feeding direction, it is possible to eliminate difficulty of the process for eliminating the abnormal feeding caused by entrance of the recording material into the gap between the roller and the separation claw disposed downstream of the nip. Further, the abnormal feeding eliminating process can be performed without enlarging the space for permitting the abnormal feeding eliminating process in the upstream side of the nip and without damaging the first and second rotatable members.

### Second Embodiment

In Second Embodiment of the present invention, different from First Embodiment, in the case where the recording material caused the jam in the neighborhood of the fixing nip N, a jam clearance method is changed depending on the basis weight of the recording material (first and third control modes described later). In the case where the basis weight of the recording material does not exceed 250 gsm as a predetermined value, the rigidity of the recording material is small, and therefore the recording material can be crumpled in the jam clearance space E as shown in (a) of FIG. 9.

Accordingly, in this case, the controller A as the control portion effects the control of an operation in the following control mode (third control mode). That is, the pressing roller 41 is spaced from the fixing roller 40 by the urging mechanism 70, and the claw-spacing solenoids 38 and 88 are turned on, so that the separation claws 34 and 84 are retracted from the surfaces of the fixing roller 40 and the pressing roller 41 to enable removal of the jammed recording material in the jam clearance space E.

In the case where the basis weight of the recording material exceeds 250 gsm as a predetermined value, the rigidity of the recording material is large, and therefore it is difficult to crumple the recording material in the jam clearance space E as shown in (b) of FIG. 9. Accordingly, in this case, the controller A as the control means effects the control of an operation in the following control mode (first control mode). That is, the pressing roller 41 is spaced from the fixing roller 40 by the urging mechanism 70, and the claw-spacing solenoids 38 and 88 are turned off, so that the upper separation claw 34 and the lower separation claw 84 are contacted to the fixing roller 40 and the pressing roller 41, respectively.

As a result, the gap formed between the pressing roller 41 and the feeding guide disposed downstream of the fixing nip N is closed by the lower separation claw 84, so that the jammed recording material is placed in a feedable state toward a downstream position with respect to the recording material feeding direction. Thereafter, the feeding belt 140 is rotated to feed the recording material until the feeding sensor 91 detects the recording material leading end. Then, the pulling-out unit D is pulled out toward the image forming apparatus front surface, and then the jammed recording material is removed.

In this embodiment, by rotating the feeding belt 140, the jammed recording material is fed until the feeding sensor 91 detects the leading end of the recording material, but the user sends the jammed recording material and thereafter pulls out the pulling-out unit D toward the front surface of the image forming apparatus, and then the user may also remove the jammed recording material.

Also in this embodiment, similarly as in First Embodiment, the controller A effects the following control as an operation in a control mode (second control mode) in the fixing process. That is, the pressing roller 41 is placed in the contact state to the fixing roller 40, and in the case where the basis weight of the recording material exceeds a threshold, the lower separation claw 84 is placed in the retracted (spaced) state from the pressing roller 40. On the other hand, in the case where the basis weight of the recording material does not exceed the threshold, the lower separation claw 84 is placed in the contact state to the pressing roller 41. Further, in this embodiment, similarly as the contact and separation (spacing) of the lower separation claw 84 relative to the pressing roller 41, the contact and separation of the upper separation claw 34 relative to the fixing roller 40 is simultaneously carried out.

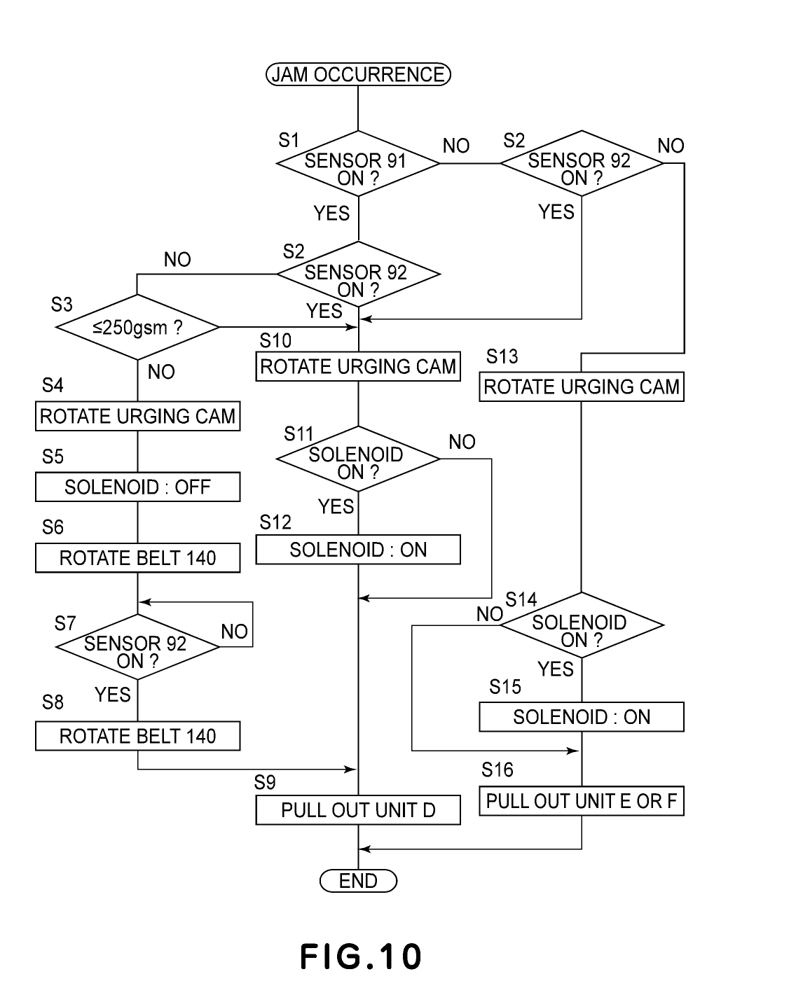

Next, by using the schematic illustration of the image forming apparatus 100 of FIG. 2 and the flowchart of FIG. 10, an operation when the jam occurs during the printing will be described. During the printing, when the jam occurs in the neighborhood of the fixing nip N, the controller A checks the state of each of the feeding sensors 91 and 92 provided in the image forming apparatus 100 (S1, S2).

(A) Case where Feeding Sensor 91 Detects Recording Material and Feeding Sensor 92 does not Detect Jammed Recording Material

In this case, the controller A discriminates that the recording material leading end position is located in the fixing nip N and also upstream of the fixing nip N. In the case where the basis weight of the recording material which is to be used by being passed through the fixing nip N does not exceed 250 gsm, the controller A spaces the pressing roller 41 from the fixing roller 40 by the urging mechanism 70 (S10). Then, in the case where the upper separation claw 34 and the lower separation claw 84 are contacted to the fixing roller 40 and the pressing roller 41 (S11), the claw-spacing solenoids 38 and 88 are turned on, so that the upper separation claw 34 and the lower separation claw 84 are spaced from the fixing roller 40 and the pressing roller 41 (S12). In this state, guidance is displayed at the separating display portion B so that the user removes the recording material jammed in the jam clearance space E (S9).

On the other hand, in the case where the basis weight of the recording material which is to be used by being passed through the fixing nip N does not exceed 250 gsm, the controller A spaces the pressing roller 41 from the fixing roller 40 by the urging mechanism 70 (S4). Then, the claw-spacing solenoids 38 and 88 are turned off, so that the upper separation claw 34 and the lower separation claw 84 are contacted to the fixing roller 40 and the pressing roller 41 (S5). Thereafter, the feeding belt 140 is rotated (S6), so that the jammed recording material is fed until the feeding sensor 91 detects the recording material leading end (S7). In this state, guidance is displayed at the operating display portion B so that the user pulls out the pulling-out unit D to the image forming apparatus front surface side and then removes the jammed recording material (S9).

(B) Case where Feeding Sensors 91 and 92 Detect Jammed Recording Material

In this case, the controller A discriminates that the recording material leading end position is located downstream of the fixing nip N. Then, the controller A spaces the fixing roller 40 from the pressing roller 41 by the urging mechanism 70 (S10). Then, in the case where the upper separation claw 34 and the lower separation claw 84 are contacted to the fixing roller 40 and the pressing roller 41 (S11), the claw-spacing solenoids 38 and 88 are turned on, so that the upper separation claw 34 and the lower separation claw 84 are retracted from the fixing roller 40 and the pressing roller 41 (S12). In this state, guidance is displayed at the operating display portion B so that the user pulls out the pulling-out unit D to the front surface side of the image forming apparatus 100 and then removes the jammed recording material (S9).

(C) Case where Feeding Sensors 91 does not Detect Recording Material and Feeding Sensor 92 Detect Jammed Recording Material

In this case, the controller A discriminates that the recording material leading end position is located downstream of the fixing nip N. Then, the controller A spaces the fixing roller 40 from the pressing roller 41 by the urging mechanism 70 (S10). Then, in the case where the upper separation claw 34 and the lower separation claw 84 are contacted to the fixing roller 40 and the pressing roller 41 (S11), the claw-spacing solenoids 38 and 88 are turned on, so that the upper separation claw 34 and the lower separation claw 84 are retracted from the fixing roller 40 and the pressing roller 41 (S12). In this state, guidance is displayed at the operating display portion B so that the user pulls out the pulling-out unit D to the front surface side of the image forming apparatus 100 and then removes the jammed recording material (S9).

(D) Case where Feeding Sensors 91 and 92 do not Detect Jammed Recording Material

In this case, the controller A discriminates that the recording material leading end position is not located in the neighborhood of the fixing nip N. The controller A spaces the fixing roller 40 from the pressing roller 41 by the urging mechanism 70 (S13). Then, in the case where the upper separation claw 34 and the lower separation claw 84 are contacted to the fixing roller 40 and the pressing roller 41 (S14), the claw-spacing solenoids 38 and 88 are turned on, so that the upper separation claw 34 and the lower separation claw 84 are retracted from the fixing roller 40 and the pressing roller 41 (S15). In this state, guidance is displayed at the operating display portion B so that the user pulls out another pulling-out unit E or F of the image forming apparatus 100 and then removes the jammed recording material (S16).

### Effect of this Embodiment

As described above, according to this embodiment, the jam clearance method is changed depending on the basis weight of the recording material. As a result, with respect to the recording material, having a small rigidity, which has the basis weight which does not exceed 250 gsm as the predetermined value, the jam clearance can be made even when the pulling-out unit D is not pulled out, so that the jam clearance operation is simplified.

Further, with respect to the recording material having the small rigidity as described above, the upper separation claw 34 and the lower separation claw 84 are retracted from the fixing roller 40 and the pressing roller 41. For this reason, the upper separation claw 34 and the lower separation claw 84 are not pressed against the fixing roller 40 and the pressing roller 41 by the jammed recording material, s that the surfaces of the fixing roller 40 and the pressing roller 41 are not damaged by the upper separation claw 34 and the lower separation claw 84.

On the other hand, with respect to the recording material, having the large rigidity, which has the basis weight exceeding 250 gsm as the predetermined value, the gap formed between the pressing roller 41 and the feeding guide disposed downstream of the fixing nip N is closed by the lower separation claw 84, so that the jammed recording material is fed downstream with respect to the feeding direction without entering the gap.

### Third Embodiment

In Third Embodiment of the present invention, two positions where the pressing roller 41 is spaced from the fixing roller 40 by the urging mechanism 70 are provided, and a spacing amount of the pressing roller 41 from the fixing roller 40 is made changeable. A first spaced position is the spaced position in First and Second Embodiments and is the position where the lower separation claw 84 contacts the pressing roller 41 in the spaced state of the pressing roller 41 from the fixing roller 40. On the other hand, a second spaced position is the position where the spacing amount of the pressing roller 41 from the fixing roller 40 is larger than the spacing amount at the first spaced position.

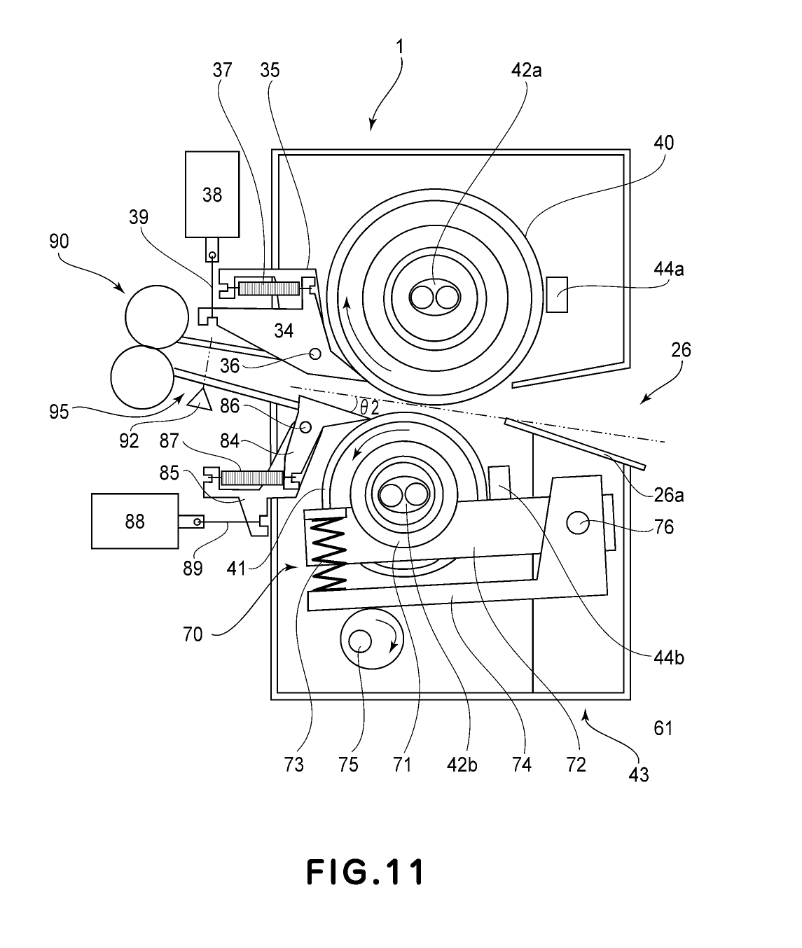

As described in First Embodiment, in order to prevent the lower separation claw 84 from being pressed and rotated by the recording material to be discharged through the fixing nip N, as shown in FIG. 11, the angle θ2 formed between the edge line 84a of the lower separation claw 84 and the discharging direction of the recording material to be discharged through the fixing nip N may preferably be made 30° or less. Accordingly, when the lower separation claw 84 is contacted to the pressing roller 41 in the state in which the pressing roller 41 is spaced from the fixing roller 40, in order to make this angle θ2 30° or less, the spacing amount between the fixing roller 40 and the pressing roller 41 is 2 m.

The second spaced position is the position where the lower separation claw 84 is retracted (spaced) from the pressing roller 41 in the spaced state of the pressing roller 41 from the fixing roller 40. At this time, the spacing amount between the fixing roller 40 and the pressing roller 41 is 5 mm.

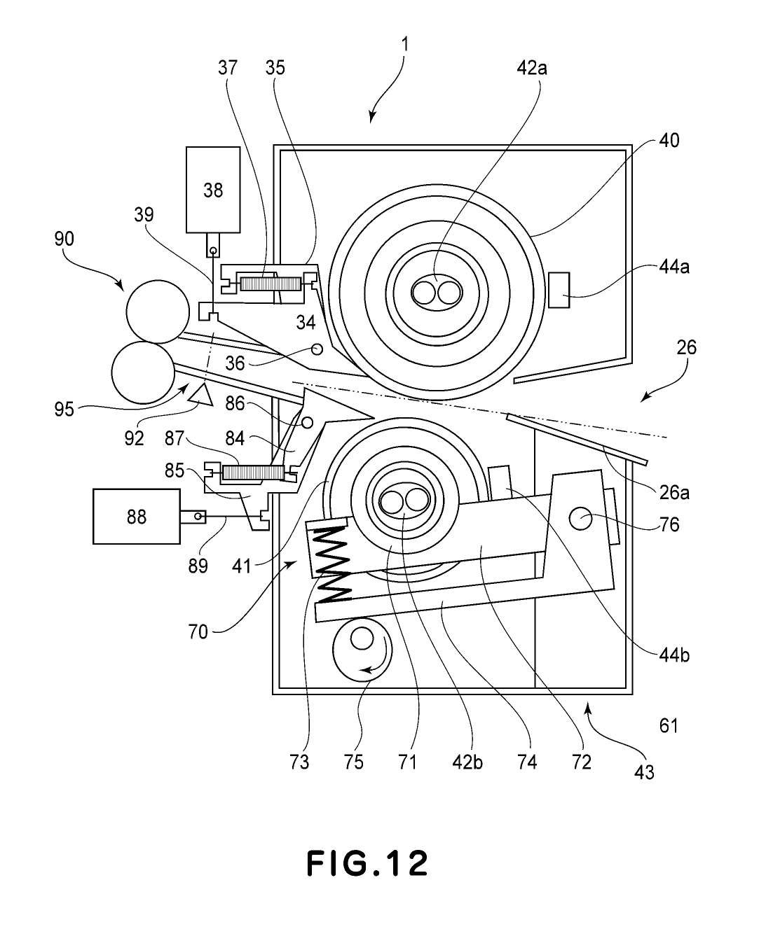

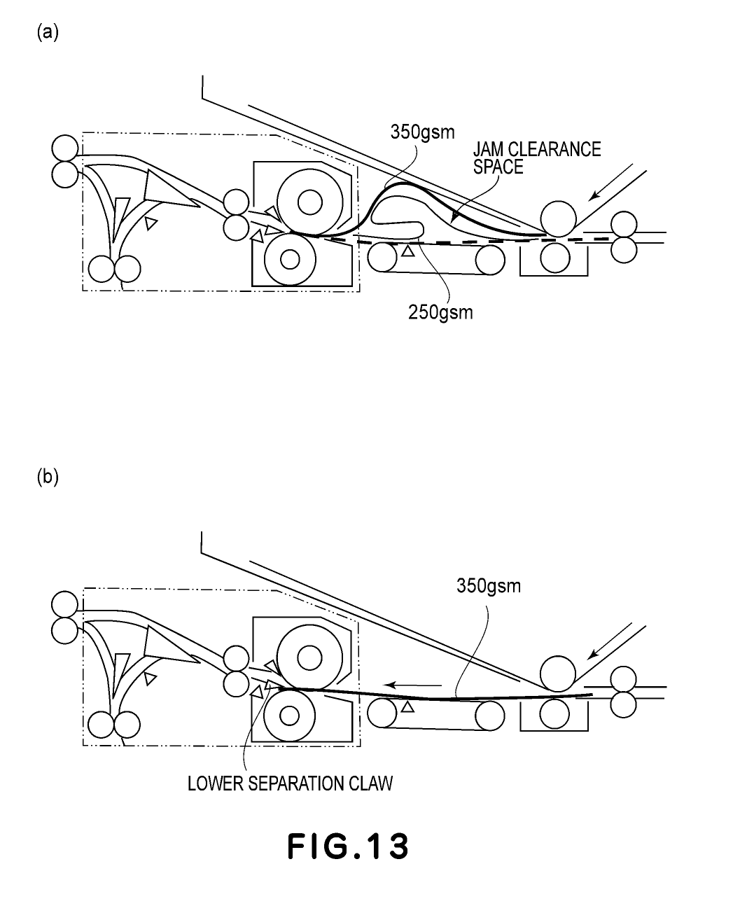

The spacing amount between the fixing roller 40 and the pressing roller 41 is applicable by a rotation angle of an urging cam 75 of the urging mechanism 70. When the urging cam 75 is rotated in the clockwise direction by 90° as shown in FIG. 11, the pressing roller 41 is spaced from the fixing roller 40 to the first spaced position, and when the urging cam 75 is rotated in the clockwise direction by 180° as shown in FIG. 12, the pressing roller 41 is spaced from the fixing roller 40 to the second spaced position.

In this embodiment, similarly as in First Embodiment, in the case where the recording material caused the jam in the neighborhood of the fixing nip N, the jam clearance method is changed depending on the basis weight of the recording material (first and third control modes). In the case where the basis weight of the recording material does not exceed 250 gsm as a predetermined value, the rigidity of the recording material is small, and therefore the recording material can be crumpled in the jam clearance space E as shown in (a) of FIG. 9.

Accordingly, in this case, the controller A as the control means effects the control of an operation in the following control mode (third control mode). That is, the pressing roller 41 is spaced from the fixing roller 40 by the urging mechanism 70, and the claw-spacing solenoids 38 and 88 are turned on, so that the separation claws 34 and 84 are retracted from the surfaces of the fixing roller 40 and the pressing roller 41 to enable removal of the jammed recording material in the jam clearance space E.

In this case, different from Second Embodiment, the pressing roller 41 is spaced by the urging mechanism 70 from the fixing roller 40 to the second spaced position, not the first spaced position. Then, the claw-spacing solenoids 38 and 88 are turned off, so that the upper separation claw 34 and the lower separation claw 84 are retracted from the surfaces of the fixing roller 40 and the pressing roller 41. As a result, the jammed recording material is removable in the jam clearance space E.

In the case where the basis weight of the recording material exceeds 250 gsm as a predetermined value, the rigidity of the recording material is large, and therefore it is difficult to crumple the recording material in the jam clearance space E as shown in (b) of FIG. 9. Accordingly, in this case, the controller A as the control means effects the control of an operation in the following control mode (first control mode).

That is, the pressing roller 41 is spaced from the fixing roller 40 is the first spaced position by the urging mechanism 70, and the claw-spacing solenoids 38 and 88 are turned off, so that the upper separation claw 34 and the lower separation claw 84 are contacted to the fixing roller 40 and the pressing roller 41, respectively. As a result, the gap formed between the pressing roller 41 and the feeding guide disposed downstream of the fixing nip N is closed by the lower separation claw 84, so that the jammed recording material is placed in a feedable state toward a downstream position with respect to the recording material feeding direction.

Thereafter, the feeding belt 140 is rotated to feed the recording material until the feeding sensor 91 detects the recording material leading end. Then, the pulling-out unit D is pulled out toward the front surface of the image forming apparatus 100, and then the jammed recording material is removed.

In this embodiment, by rotating the feeding belt 140, the jammed recording material is fed until the feeding sensor 91 detects the leading end of the recording material, but the user sends the jammed recording material and thereafter pulls out the pulling-out unit D toward the front surface of the image forming apparatus, and then the user may also remove the jammed recording material.

Also in this embodiment, similarly as in First and Second Embodiments the controller A as the control portion effects the following control as an operation in a control mode (second control mode) in the fixing process. That is, the pressing roller 41 is placed in the contact state to the fixing roller 40, and in the case where the basis weight of the recording material exceeds a threshold, the lower separation claw 84 is placed in the retracted (spaced) state from the pressing roller 40. On the other hand, in the case where the basis weight of the recording material does not exceed the threshold, the lower separation claw 84 is placed in the contact state to the pressing roller 41. Further, in this embodiment, similarly as the contact and separation (spacing) of the lower separation claw 84 relative to the pressing roller 41, the contact and separation of the upper separation claw 34 relative to the fixing roller 40 is simultaneously carried out.

### Effect of this Embodiment

As described above, according to this embodiment, the spacing amount at the first spaced position is made larger than the spacing amount at the second spaced position. As a result, a recording material deformable space, during the jam occurrence, such that the recording material is deformed in a bellow shape by being caught at the leading end thereof by the feeding guide 95 disposed downstream of the fixing nip N can be enlarged. As a result, the surface damage of the fixing roller 40 and the pressing roller 41 can be reduced by the deformed recording material.

As described above, the preferred embodiments of the present invention was described, but the present invention is not limited thereto and can be modified within the scope of the present invention.

For example, as the fixing device, the description was made by taking, as an example, the device in which the (unfixed) toner image formed on the recording material (sheet) is heated and fixed, but the present invention is similarly applicable to the following device. For example, the present invention is applicable to a device in which gloss (glossiness) of an image is increased by heating a toner image temporarily fixed on the recording material to be fixed again on the recording material.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 223084/2013 filed Oct. 28, 2013, which is hereby incorporated by reference.

What is claimed is:

1. An image forming apparatus comprising:
an image forming portion configured to form a toner image on a sheet;
a first rotatable member and a second rotatable member which are configured to form a nip therebetween for heating the toner image formed on the sheet by said image forming portion;
a separation member configured to separate the sheet in contact with said second rotatable member;
a moving mechanism configured to move said separating member so that said separating member is movable to a contact position contacting said second rotatable member and a spaced position spaced from said second rotatable member; and
a controller configured to control an operation of said moving mechanism,
wherein said controller moves said separating member from the spaced position to the contact position by said moving mechanism when an image forming process is interrupted in a state in which said separating member is in the spaced position.

2. An image forming apparatus according to claim 1, further comprising a feeding mechanism configured to feed the sheet,
wherein when the image forming process is interrupted, after said separating member is moved from the spaced position to the contact position, said feeding mechanism feeds the sheet stagnating at a position upstream nip of the nip with respect to a sheet feeding direction toward a position downstream of the nip with respect to the sheet feeding direction.

3. An image forming apparatus according to claim 2, further comprising:
a first sensor provided upstream of the nip with respect to the sheet feeding direction and configured to detect the sheet; and
a second sensor provided downstream of the nip with respect to the sheet feeding direction and configured to detect the sheet,
wherein the image forming process is interrupted when the sheet is not detected by said second sensor within a predetermined time from detection of the sheet by said first sensor, and
wherein when the image forming process is interrupted, after said separating member is moved from the spaced position to the contact position, said feeding mechanism feeds the stagnated sheet so that the stagnated sheet is detected by said second sensor.

4. An image forming apparatus according to claim 1, wherein when the image forming process is performed, said controller effect control s that said separating member is moved to the contact position or the spaced position depending on a species of the sheet.

5. An image forming apparatus according to claim 4, wherein said controller effects control so that said separating member is moved to the spaced position when the image forming process of the sheet having a basis weight more than a predetermined basis weight is performed and so that said separating member is moved to the contact position when the image forming process of the sheet having a basis weight not more than the predetermined between.

6. An image forming apparatus according to claim 1, wherein when said separating member is moved from the spaced position to the contact position with the interruption of the image forming process, said controller effects control so that said separating member is moved from the contact position to the spaced position so as to resume the image forming process with removal of the sheet from an inside of said image forming apparatus.

7. An image forming apparatus according to claim 1, further comprising:
a first sensor provided upstream of the nip with respect to the sheet feeding direction and configured to detect the sheet; and
a second sensor provided downstream of the nip with respect to the sheet feeding direction and configured to detect the sheet,
wherein the image forming process is interrupted when the sheet is not detected by said second sensor within a predetermined time from detection of the sheet by said first sensor.

8. An image forming apparatus comprising:
an image forming portion configured to form a toner image on a sheet;
a first rotatable member and a second rotatable member which are configured to form a nip therebetween for heating the toner image formed on the sheet by said image forming portion;
a first moving mechanism configured to move said separating member so that said separating member is movable to a contact position contacting said first rotatable member and a spaced position spaced from said first rotatable member;
a separation member configured to separate the sheet in contact with said second rotatable member;
a second moving mechanism configured to move said separating member so that said separating member is movable to a contact position contacting said second rotatable member and a spaced position spaced from said second rotatable member; and
a controller configured to control an operation of each of said first and second moving mechanisms,
wherein said controller moves said separating member from the spaced position to the contact position by said moving mechanism while moving said second rotatable member from the contact position to the spaced position by said first moving mechanism when an image forming process is interrupted in a state in which said separating member is in the spaced position.

9. An image forming apparatus according to claim 8, further comprising a feeding mechanism configured to feed the sheet,
wherein when the image forming process is interrupted, after said separating member is moved from the spaced position to the contact position, said feeding mechanism feeds the sheet stagnating at a position upstream nip of the nip with respect to a sheet feeding direction toward a position downstream of the nip with respect to the sheet feeding direction.

10. An image forming apparatus according to claim 9, further comprising:
a first sensor provided upstream of the nip with respect to the sheet feeding direction and configured to detect the sheet; and
a second sensor provided downstream of the nip with respect to the sheet feeding direction and configured to detect the sheet,
wherein the image forming process is interrupted when the sheet is not detected by said second sensor within a predetermined time from detection of the sheet by said first sensor, and
wherein when the image forming process is interrupted, after said separating member is moved from the spaced position to the contact position, said feeding mechanism feeds the stagnated sheet so that the stagnated sheet is detected by said second sensor.

11. An image forming apparatus according to claim 8, wherein when the image forming process is performed, said controller effect control s that said separating member is moved to the contact position or the spaced position depending on a species of the sheet.

12. An image forming apparatus according to claim 11, wherein said controller effects control so that said separating member is moved to the spaced position when the image forming process of the sheet having a basis weight more than a predetermined basis weight is performed and so that said separating member is moved to the contact position when the image forming process of the sheet having a basis weight not more than the predetermined between.

13. An image forming apparatus according to claim 8, wherein when said separating member is moved from the spaced position to the contact position with the interruption of the image forming process, said controller effects control so that said separating member is moved from the contact position to the spaced position so as to resume the image forming process with removal of the sheet from an inside of said image forming apparatus.

14. An image forming apparatus according to claim 8, further comprising:
a first sensor provided upstream of the nip with respect to the sheet feeding direction and configured to detect the sheet; and
a second sensor provided downstream of the nip with respect to the sheet feeding direction and configured to detect the sheet,
wherein the image forming process is interrupted when the sheet is not detected by said second sensor within a predetermined time from detection of the sheet by said first sensor.
